(19) United States
(12) Patent Application Publication
(10) Pub. No.: US 2023/0187891 A1
(43) Pub. Date: Jun. 15, 2023

(54) OPTICAL AMPLIFICATION APPARATUS AND OPTICAL AMPLIFICATION SYSTEM

(71) Applicant: Fujitsu Limited, Kawasaki-shi (JP)

(72) Inventor: Norifumi Shukunami, Yokohama (JP)

(73) Assignee: Fujitsu Limited, Kawasaki-shi (JP)

(21) Appl. No.: 17/955,593

(22) Filed: Sep. 29, 2022

(30) Foreign Application Priority Data
Dec. 15, 2021 (JP) 2021-203275

(51) Int. Cl. H01S 3/067; H04J 14/02

(52) U.S. Cl. CPC H01S 3/06766; H04J 14/0221; H01S 3/06775

(57) ABSTRACT

An optical amplification apparatus includes: a light source that outputs to an optical transmission path first pump light which Raman amplifies signal light input from the optical transmission path and which is of a first wavelength band; a first detector that detects input, from the optical transmission path, of second pump light of a second wavelength band which is different from the first wavelength band; and a processor that performs safety light control on the light source in a case where the input of the second pump light is not detected.

### CROSS-REFERENCE TO RELATED APPLICATION

This application is based upon and claims the benefit of priority of the prior Japanese Patent Application No. 2021-203275, filed on Dec. 15, 2021, the entire contents of which are incorporated herein by reference.

### FIELD

The embodiments discussed herein are related to an optical amplification apparatus and an optical amplification system.

### BACKGROUND

Backward pumping Raman amplification is known in which pump light enters an optical transmission path (for example, an optical fiber) for Raman amplification so as to propagate in an opposite direction to a propagation direction of signal light. Also, forward pumping Raman amplification is known in which pump light enters an optical transmission path for Raman amplification so as to propagate in the same direction as the propagation direction of signal light. In addition, a technique called bidirectional pumping Raman amplification is known in which the forward pumping Raman amplification and the backward pumping Raman amplification are simultaneously used.

Japanese Laid-open Patent Publication No. 2016-212370, International Publication Pamphlet No. WO 2002/021204, and Japanese Laid-open Patent Publication No. 2003-114453 are disclosed as related art.

### SUMMARY

According to an aspect of the embodiments, an optical amplification apparatus includes: a light source that outputs to an optical transmission path first pump light which Raman amplifies signal light input from the optical transmission path and which is of a first wavelength band; a first detector that detects input, from the optical transmission path, of second pump light of a second wavelength band which is different from the first wavelength band; and a processor that performs safety light control on the light source in a case where the input of the second pump light is not detected.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a transmission system;

FIG. 2 illustrates an example of an optical amplification system according to a first embodiment;

FIG. 3 illustrates an example of an optical amplification system according to a comparative example;

FIG. 4 is a flowchart illustrating an example of operation of a forward control unit according to the first embodiment;

FIG. 5 is a flowchart illustrating an example of operation of a backward control unit according to the first embodiment;

FIG. 6 illustrates an example of an optical amplification system according to a second embodiment; and

FIG. 7 is a flowchart illustrating part of an example of operation of a forward control unit according to the second embodiment.

### DESCRIPTION OF EMBODIMENTS

For example, signal light of a 1550 nanometer (nm) band is forward pumped by primary pump light of a 1450 nm band (hereinafter, referred to as incoherent pump light) in the forward pumping Raman amplification. However, since the power of the incoherent pump light is small at an entrance end of an optical transmission path, a Raman gain of the signal light tends to be small at the entrance end of the optical transmission path. Accordingly, in some cases, the incoherent pump light is Raman amplified by secondary pump light of the 1350 nm band, and the Raman amplified incoherent pump light Raman amplifies the signal light.

Thus, as the signal light is transmitted, the incoherent pump light is amplified by the secondary pump light, and the Raman gain for the signal light increases. As a result, when the entirety of the optical transmission path is taken into account, a loss and the Raman gain of the optical transmission path successfully cancel out each other, and the optical transmission path may be regarded as such an optical transmission path the transmission loss of which appears to be 0 (zero). An optical amplification apparatus using the Raman amplification is known.

Meanwhile, in a case where an optical connector that couples the optical amplification apparatus using the backward pumping Raman amplification and the optical transmission path is decoupled, pump light entering the optical transmission path from the optical amplification apparatus (hereafter, referred to as backward pump light where appropriate) may be emitted to the surrounding region. Emission of the backward pump light may impair the safety of an operator during installation work of the optical transmission path.

In order to suppress such an emission of the backward pump light, it is desirable to perform safety light control in a case where the optical connector is decoupled. The safety light control is control that stops output of the pump light or reduces optical power of the pump light to optical power that is safe for the surrounding region. For example, when the optical connector is decoupled, the reflected light of the backward pump light is input to the original optical amplification apparatus (for example, the optical amplification apparatus using the backward pumping Raman amplification). Thus, in a case where the reflected light is detected, the emission of the backward pump light may be suppressed by performing the safety light control. Thus, the safety of the operator may be ensured.

However, in the case of the above-described bidirectional pumping Raman amplification, when the optical connector is not decoupled, the incoherent pump light and the secondary pump light of the optical amplification apparatus using the forward pumping Raman amplification are input to the optical amplification apparatus using the backward pumping Raman amplification. When the wavelength band of the incoherent pump light and the wavelength band of the backward pump light are the same, the incoherent pump light may be detected as the reflected light of the backward pump light.

For example, even though the optical connector is not decoupled, malfunction in which the safety light control is performed by normal input of the incoherent pump light may occur. The malfunction of the optical amplification apparatus may impair the safety of the operator. In addition, from the viewpoints of ensuring the safety of the operator, in the case where the optical connector is decoupled, it is desirable that the safety light control be performed not only on the optical amplification apparatus using the backward pumping Raman amplification but also on the optical amplification apparatus using the forward pumping Raman amplification.

In one aspect, it is an object to provide an optical amplification apparatus and an optical amplification system that improve safety of an operator.

Hereinafter, embodiments of the present disclosure are described with reference to the drawings.

### First Embodiment

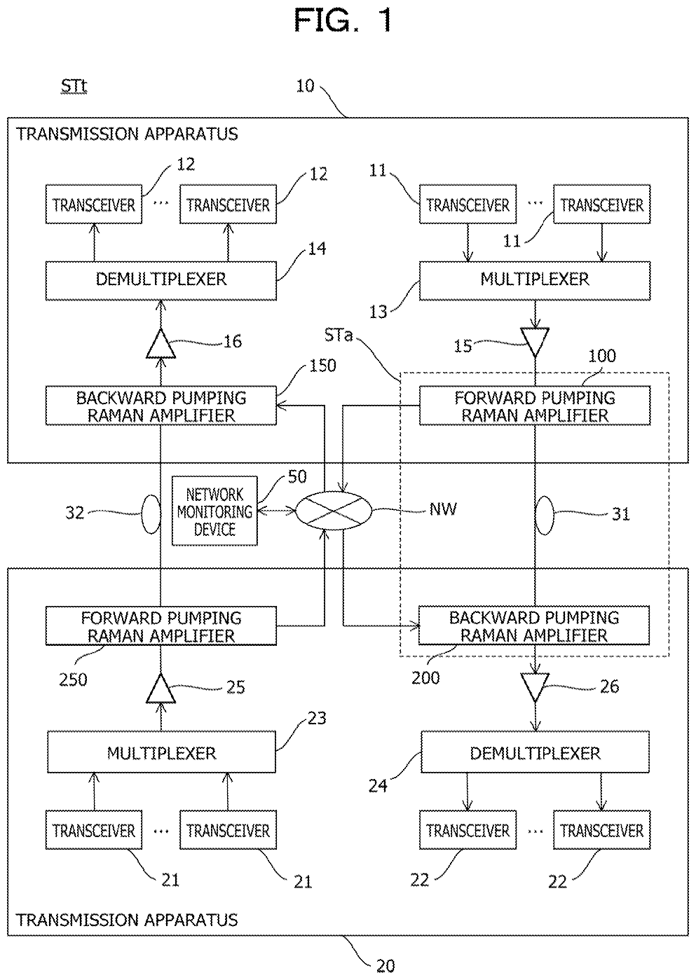

As illustrated in FIG. 1, a transmission system STt includes two transmission apparatuses 10 and 20. The transmission apparatuses 10 and 20 are coupled to each other via two optical transmission paths 31 and 32. The optical transmission paths 31 and 32 include, for example, optical fibers. The optical transmission paths 31 and 32 may or may not be included in the transmission system STt.

The transmission apparatus 10 includes a plurality of transceivers 11, a plurality of transceivers 12, a multiplexer 13, a demultiplexer 14, optical amplifiers 15 and 16, a forward pumping Raman amplifier 100, and a backward pumping Raman amplifier 150. The forward pumping Raman amplifier 100 is an example of an optical amplification apparatus (in more detail, a first optical amplification apparatus and an other optical amplification apparatus). The transmission apparatus 20 includes a plurality of transceivers 21, a plurality of transceivers 22, a multiplexer 23, a demultiplexer 24, optical amplifiers 25 and 26, a backward pumping Raman amplifier 200, and a forward pumping Raman amplifier 250. The backward pumping Raman amplifier 200 is an example of an optical amplification apparatus (in more detail, a second optical amplification apparatus). The forward pumping Raman amplifier 100 is coupled to the backward pumping Raman amplifier 200 via the optical transmission path 31. The forward pumping Raman amplifier 250 is coupled to the backward pumping Raman amplifier 150 via the optical transmission path 32.

For example, an optical amplification system STa may be built by the forward pumping Raman amplifier 100 and the backward pumping Raman amplifier 200. The optical transmission path 31 may or may not be included in the optical amplification system STa. The optical amplification system STa may be built by the forward pumping Raman amplifier 250 and the backward pumping Raman amplifier 150. The optical transmission path 32 may or may not be included in such an optical amplification system STa.

The plurality of transceivers 11 respectively transmit a plurality of wavelength light beams having wavelengths different from each other. The plurality of transceivers 12 respectively receive a plurality of wavelength light beams having wavelengths different from each other. The multiplexer 13 combines a plurality of wavelength light beams having wavelengths different from each other to generate wavelength multiplexed signal light (hereafter, simply referred to as signal light). The demultiplexer 14 separates, from the signal light, wavelength light beams of central wavelengths at fixed wavelength intervals. The multiplexer 13 and the demultiplexer 14 include, for example, optical couplers.

Each of the optical amplifiers 15 and 16 amplifies the signal light. The optical amplifier 15 and 16 include, for example, erbium-doped fiber amplifiers (EDFAs). The forward pumping Raman amplifier 100 outputs forward pump light to the optical transmission path 31 in the same direction as that of the signal light. When the forward pump light enters the optical transmission path 31, induced Raman scattering is generated and the signal light is Raman amplified. The backward pumping Raman amplifier 150 outputs backward pump light to the optical transmission path 32 in the opposite direction to that of the signal light. When the backward pump light enters the optical transmission path 32, the induced Raman scattering is generated and the signal light is Raman amplified.

Since the plurality of transceivers 21 and 22 have basically similar functions to those of the plurality of transceivers 11 and 12 described above, detailed description of the plurality of transceivers 21 and 22 is omitted. Likewise, since the multiplexer 23 and the demultiplexer 24 have basically similar functions to those of the multiplexer 13 and the demultiplexer 14 described above, detailed description of the multiplexer 23 and the demultiplexer 24 is omitted. Since the optical amplifiers 25 and 26 have basically similar functions to those of the optical amplifiers 15 and 16 described above, detailed description thereof is omitted. Since the backward pumping Raman amplifier 200 and the forward pumping Raman amplifier 250 have basically similar functions as those of the backward pumping Raman amplifier 150 and the forward pumping Raman amplifier 100 described above, detailed description of the backward pumping Raman amplifier 200 and the forward pumping Raman amplifier 250 is omitted.

The forward pumping Raman amplifiers 100 and 250 and the backward pumping Raman amplifiers 150 and 200 are coupled to a network monitoring device 50 via a communication network NW. The communication network NW includes one or both of a local area network (LAN) and the Internet. The network monitoring device 50 receives various types of information from the forward pumping Raman amplifiers 100 and 250. The network monitoring device 50 transmits various types of information to the backward pumping Raman amplifiers 150 and 200. The details of the network monitoring device 50 will be described later.

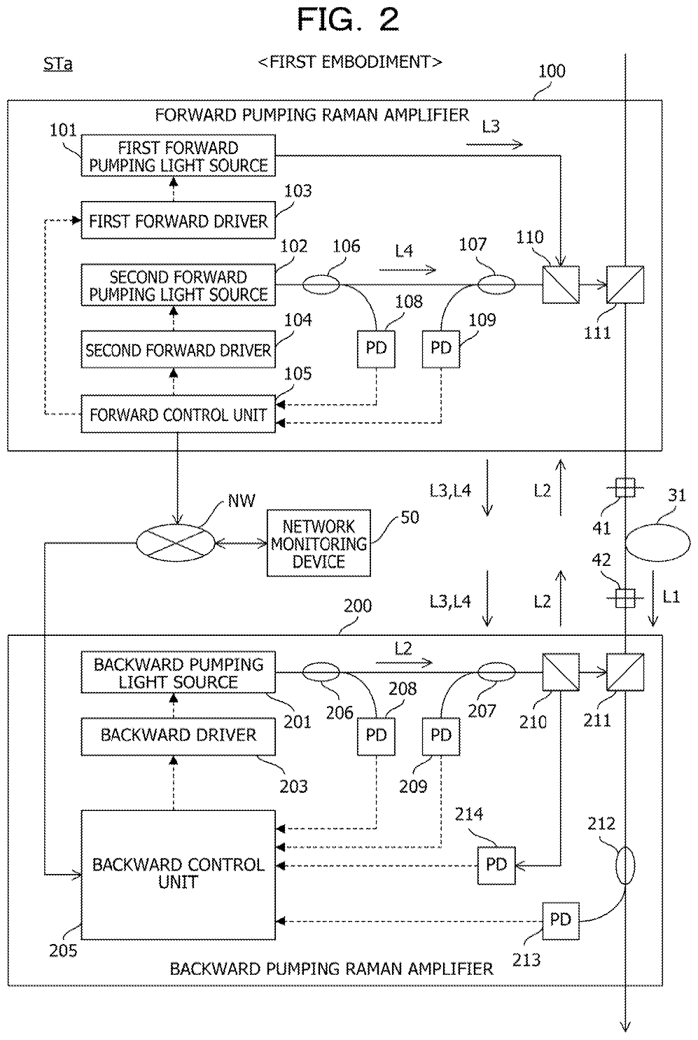

With reference to FIG. 2, the details of the forward pumping Raman amplifier 100 and the backward pumping Raman amplifier 200 included in the optical amplification system STa are described.

First, the forward pumping Raman amplifier 100 is described. The forward pumping Raman amplifier 100 includes a first forward pumping light source 101, a second forward pumping light source 102, a first forward driver 103, a second forward driver 104, and a forward control unit 105. The first forward pumping light source 101 is an example of a first light source. The second forward pumping light source 102 is an example of a second light source. The forward control unit 105 is an example of a control unit. The forward pumping Raman amplifier 100 also includes taps 106 and 107, photo diodes (PDs) 108 and 109, and optical filters 110 and 111.

The first forward pumping light source 101 outputs incoherent pump light L3 of a first wavelength band (for example, a 1450 nm band). The second forward pumping light source 102 outputs secondary pump light L4 of a second wavelength band (for example, a 1350 nm band) different from the first wavelength band. Thus, the second wavelength band is a wavelength band narrower than the first wavelength band. The incoherent pump light L3 is pump light that amplifies signal light L1 of a third wavelength band (for example, a 1550 nm band) different from both the first wavelength band and the second wavelength band. The secondary pump light L4 is pump light that Raman amplifies the incoherent pump light L3. The first forward pumping light source 101 and the second forward pumping light source 102 include, for example, laser diodes (LDs).

For example, the first forward driver 103 stops driving of the first forward pumping light source 101 based on a first control signal output from the forward control unit 105. Instead of stopping the driving, the first control signal that reduces the power of the incoherent pump light L3 to the power safe for an operator during installation work of the optical transmission path 31 may be employed. For example, the second forward driver 104 stops driving of the second forward pumping light source 102 based on a second control signal output from the forward control unit 105. Instead of stopping the driving, the second control signal that reduces the power of the secondary pump light L4 to the power safe for the above-described operator may be employed. Thus, safety light control may be realized by stopping the driving or reducing the power.

The forward control unit 105 outputs the first control signal, thereby to control, via the first forward driver 103, operation of the first forward pumping light source 101. The forward control unit 105 outputs the second control signal, thereby to control, via the second forward driver 104, operation of the second forward pumping light source 102. The forward control unit 105 includes a hardware circuit such as, for example, a field-programmable gate array (FPGA). Instead of the FPGA, the forward control unit 105 may be a hardware circuit such as an application-specified integrated circuit (ASIC) or a central processing unit (CPU).

The tap 106 splits the secondary pump light L4 and outputs the split secondary pump light L4 to the tap 107 and the PD 108. The tap 107 splits the reflected light of the secondary pump light L4 (for example, reflected pump light) and outputs the split reflected light of the secondary pump light L4 to the tap 106 and the PD 109. The taps 106 and 107 include, for example, beam splitters or optical couplers.

The PD 108 detects the power of the secondary pump light L4. The forward control unit 105 obtains this power from an output signal of the PD 108. The PD 109 detects the power of the reflected light of the secondary pump light L4. The forward control unit 105 obtains this power from an output signal of the PD 109. Based on the ratio of these two obtained powers, the forward control unit 105 calculates the return loss.

For example, in a case where both of optical connectors 41 and 42 are coupled, the return loss calculated by the forward control unit 105 is greater than or equal to the threshold. As long as the return loss remains greater than or equal to the threshold, the forward control unit 105 stops the generation of the first control signal and the second control signal. Thus, driving of the first forward pumping light source 101 and the second forward pumping light source 102 continue. In contrast, in a case where one or both of the optical connectors 41 and 42 are decoupled, Fresnel reflection from the end surfaces of the optical connector 41 and 42 is generated. Thus, the return loss calculated by the forward control unit 105 is smaller than the threshold. When the return loss becomes smaller than the threshold, the forward control unit 105 generates the first control signal and the second control signal. Thus, the safety light control such as stopping of the driving of the first forward pumping light source 101 and the second forward pumping light source 102 is performed.

The incoherent pump light L3 output from the first forward pumping light source 101 is input to the optical filter 110. The secondary pump light L4 output from the second forward pumping light source 102 is input to the optical filter 110. The optical filter 110 guides to the optical filter 111 as forward pump light L3 and forward pump light L4 the incoherent pump light L3 and the secondary pump light L4 that have been input. The backward pump light L2 of the first wavelength band, the reflected light of the forward pump light L3, and the reflected light of the forward pump light L4 that are output from the optical filter 111 are input to the optical filter 110. Out of the backward pump light L2, the forward pump light L3, and the forward pump light L4 that have been input, the optical filter 110 guides the reflected light of the incoherent pump light L3 toward the first forward pumping light source 101. Out of the forward pump light L3 and the forward pump light L4 that have been input, the optical filter 110 guides the reflected light of the secondary pump light L4 toward the second forward pumping light source 102.

For example, the optical filter 110 guides the backward pump light L2 and the reflected light of the incoherent pump light L3 both of which are of the first wavelength band toward the first forward pumping light source 101. The optical filter 110 guides the reflected light of the secondary pump light L4 of the second wavelength band toward the second forward pumping light source 102. Thus, the reflected light of the secondary pump light L4 having transmitted through the optical filter 110 is input to the PD 109 via the tap 107.

The optical filter 111 guides to the optical transmission path 31 the forward pump light L3 and the forward pump light L4 that have been input from the optical filter 110. The optical filter 111 removes the signal light L1 and its reflected light instead of allowing the signal light L1 and its reflected light to be input from the optical transmission path 31 to the optical filter 110 and guides the signal light L1 to the backward pumping Raman amplifier 200 via the optical transmission path 31 together with the forward pump light L3 and the forward pump light L4. Meanwhile, the optical filter 111 guides to the optical filter 110 the backward pump light L2, the reflected light of the forward pump light L3, and the reflected light of the forward pump light L4 that have been input from the optical transmission path 31. For example, the optical filter 111 removes the signal light L1 and its reflected light of the third wavelength band instead of guiding them to the optical filter 110. The optical filter 111 guides pump light of wavelength bands other than the third wavelength band (for example, the first wavelength band and the second wavelength band) and its reflected light to the optical filter 110. Thus, the forward pumping Raman amplifier 100 may input and output the forward pump light L3, the forward pump light L4, the backward pump light L2, the reflected light of the forward pump light L3, and the reflected light of the forward pump light L4 to and from the optical transmission path 31 via a common waveguide.

Next, the backward pumping Raman amplifier 200 is described. The backward pumping Raman amplifier 200 includes a backward pumping light source 201, a backward driver 203, and a backward control unit 205. The backward pumping light source 201 is an example of a light source (in more detail, a third light source). The backward control unit 205 is an example of the control unit. The backward pumping Raman amplifier 200 also includes taps 206, 207, and 212, PDs 208, 209, 213, and 214, and optical filters 210 and 211. The PD 214 is an example of a detection unit (in more detail, a first detection unit and a pump light detection unit). The PD 209 is an example of a second detection unit. The PD 208 is an example of a third detection unit.

The backward pumping light source 201 outputs the backward pump light L2 of the first wavelength band. The backward pump light L2 is pump light that Raman amplifies the signal light L1 of the third wavelength band. The backward pumping light source 201 includes, for example, an LD. For example, the backward driver 203 stops the driving of the backward pumping light source 201 based on a third control signal output from the backward control unit 205. Instead of stopping the driving, the third control signal that reduces the power of the backward pump light L2 to the power safe for the operator may be employed. Thus, the safety light control may be realized by stopping the driving or reducing the power.

The backward control unit 205 outputs the third control signal, thereby to control, via the backward driver 203, operation of the backward pumping light source 201. The backward control unit 205 includes a hardware circuit such as, for example, an FPGA. Instead of the FPGA, the backward control unit 205 may be a hardware circuit such as an ASIC or a CPU.

The tap 206 splits the backward pump light L2 and outputs the split backward pump light L2 to the tap 207 and the PD 208. The tap 207 splits the incoherent pump light L3 out of the reflected light of the backward pump light L2, the forward pump light L3, and the forward pump light L4 and outputs the split incoherent pump light L3 to the tap 206 and PD 209. The tap 212 splits the signal light L1 and amplified spontaneous Raman scattering (ASS) light (not illustrated) and outputs the split signal light L1 and the ASS light to the optical amplifier 26 (see FIG. 1) and the PD 213. The ASS light is scattered light generated when the pump light is input to the optical transmission path 31. The taps 206, 207, and 212 include, for example, beam splitters or optical couplers.

The PD 208 detects the power of the backward pump light L2. The backward control unit 205 obtains this power from an output signal of the PD 208. The PD 209 detects the power of the incoherent pump light L3 out of the reflected light of the backward pump light L2, the forward pump light L3, and the forward pump light L4. The backward control unit 205 obtains this power from an output signal of the PD 209. Based on the ratio of these two obtained powers, the backward control unit 205 calculates the return loss.

For example, in the case where one or both of the optical connectors 41 and 42 are decoupled, Fresnel reflection from the end surfaces of the optical connector 41 and 42 is generated. Thus, the return loss calculated by the backward control unit 205 is smaller than the threshold based on the power of the reflected light of the backward pump light L2. When the return loss becomes smaller than the threshold, the backward control unit 205 generates the third control signal. Thus, the safety light control such as stopping of the driving of the backward pumping light source 201 is normally performed. In contrast, even when both of the optical connectors 41 and 42 are coupled, the return loss calculated by the backward control unit 205 is smaller than the threshold based on the power of the incoherent pump light L3. Thus, even when both of the optical connectors 41 and 42 are coupled, the return loss is smaller than the threshold. Accordingly, the backward control unit 205 may generate the third control signal. For example, this is a factor in inducing malfunction of the safety light control. Although the details will be described later, the backward pumping Raman amplifier 200 includes the PDs 213 and 214 for removing such a factor.

The PD 213 detects the power of the signal light L1 and the power of the ASS light. The backward control unit 205 obtains these powers from an output signal of the PD 213. Based on the obtained powers, the backward control unit 205 determines coupling states of the optical connectors 41 and 42. For example, in the case where both of the optical connectors 41 and 42 are coupled, the backward control unit 205 is able to obtain the power of the signal light L1 and the power of the ASS light from the output signal of the PD 213. As long as the powers are continued to be obtained, the backward control unit 205 stops generation of the third control signal. Thus, driving of the backward pumping light source 201 is continued. In contrast, in the case where one or both of the optical connectors 41 and 42 are decoupled, neither the signal light L1 nor the ASS light is input to the backward pumping Raman amplifier 200. Accordingly, the backward control unit 205 is able to obtain neither the power of the signal light L1 nor the power of the ASS light from the output signal of the PD 213. In this case, the backward control unit 205 generates the third control signal. Thus, the safety light control such as stopping of the driving of the backward pumping light source 201 is performed.

The PD 214 detects the power of the secondary pump light L4 out of the forward pump light L3 and the forward pump light L4. The backward control unit 205 obtains this power from an output signal of the PD 214. Based on the obtained power, the backward control unit 205 determines the coupling states of the optical connectors 41 and 42. For example, in the case where both of the optical connectors 41 and 42 are coupled, the backward control unit 205 is able to obtain the power of the secondary pump light L4 from the output signal of the PD 214. As long as the power is continued to be obtained, the backward control unit 205 stops generation of the third control signal. Thus, driving of the backward pumping light source 201 is continued. In contrast, in the case where one or both of the optical connectors 41 and 42 are decoupled, neither the forward pump light L3 nor the forward pump light L4 is input to the backward pumping Raman amplifier 200. Accordingly, the backward control unit 205 is unable to obtain the power of the secondary pump light L4 from the output signal of the PD 214. In this case, the backward control unit 205 generates the third control signal. Thus, the safety light control such as stopping of the driving of the backward pumping light source 201 is performed.

The backward pump light L2 output from the backward pumping light source 201 is input to the optical filter 210. The optical filter 210 guides the input backward pump light L2 to the optical filter 211. The reflected light of the backward pump light L2 output from the optical filter 211, the forward pump light L3, and the forward pump light L4 are input to the optical filter 210. The optical filter 210 guides to the tap 207 the incoherent pump light L3 out of the reflected light of the backward pump light L2, the forward pump light L3, and the forward pump light L4. The optical filter 210 guides the secondary pump light L4 out of the forward pump light L3 and the forward pump light L4 to the PD 214.

For example, the optical filter 210 guides the reflected light of the backward pump light L2 and the incoherent pump light L3 both of which are of the first wavelength band toward the backward pumping light source 201. Thus, the reflected light of the backward pump light L2 and the incoherent pump light L3 that have transmitted through the optical filter 210 are input to the PD 209 via the tap 207. In contrast, the optical filter 210 guides the secondary pump light L4 of the second wavelength band to the PD 214.

The backward pump light L2 output from the optical filter 210 is input to the optical filter 211. The optical filter 211 guides the input backward pump light L2 to the optical transmission path 31. Instead of inputting the signal light L1 and the ASS light from the optical transmission path 31 to the optical filter 210, the optical filter 211 removes the signal light L1 and the ASS light and guides the signal light L1 and the ASS light to the tap 212.

Meanwhile, the forward pump light L3 and the forward pump light L4 output from the optical transmission path 31 are input to the optical filter 211. The optical filter 211 guides to the optical filter 210 the forward pump light L3 and the forward pump light L4 that have been input. In the case where one or both of the optical connectors 41 and 42 are decoupled, the reflected light of the backward pump light L2 is input to the optical filter 211. The optical filter 211 guides the input reflected light of the backward pump light L2 to the optical filter 210. Thus, the backward pumping Raman amplifier 200 may input and output the forward pump light L3, the forward pump light L4, the backward pump light L2, and the reflected light of the backward pump light L2 to and from the optical transmission path 31 via a common waveguide.

With the above-described configuration, in the case where one or both of the optical connectors 41 and 42 are decoupled, the reflected light of the backward pump light L2 is input to the backward pumping Raman amplifier 200. The reflected light of the backward pump light L2 is input to the PD 209. Thus, the PD 209 detects the power of the reflected light of the backward pump light L2. Meanwhile, the backward pump light L2 output from the backward pumping light source 201 is input to the PD 208. Thus, the PD 208 detects the power of the backward pump light L2. The backward control unit 205 obtains these two powers from the respective output signals of the PDs 209 and 208. When the backward control unit 205 calculates the return loss based on the ratio of the two obtained powers, the return loss is smaller than the threshold due to decoupling of the optical connectors 41 and 42. Accordingly, the backward control unit 205 generates the third control signal. Thus, in the case where the optical connectors 41 and 42 are decoupled, the safety light control such as stopping of the driving of the backward pumping light source 201 is normally performed.

In the case where the optical connectors 41 and 42 are coupled, the forward pump light L3 and the forward pump light L4 are input to the backward pumping Raman amplifier 200. Out of the forward pump light L3 and the forward pump light L4, the incoherent pump light L3 is input to the PD 209. Thus, the PD 209 detects the power of the incoherent pump light L3. Meanwhile, the backward pump light L2 output from the backward pumping light source 201 is input to the PD 208. Thus, the PD 208 detects the power of the backward pump light L2. The backward control unit 205 obtains these two powers from the respective output signals of the PDs 209 and 208. When the backward control unit 205 calculates the return loss based on the ratio of the two obtained powers, there is a possibility that the return loss is smaller than the threshold even though the optical connectors 41 and 42 are coupled. Thus, the backward control unit 205 induces generation of the third control signal. When the backward control unit 205 generates the third control signal, the performance of the safety light control on the backward pumping light source 201 is induced even though the optical connectors 41 and 42 are coupled. For example, malfunction of the backward pumping Raman amplifier 200 is induced.

However, in the case where the optical connectors 41 and 42 are coupled, the secondary pump light L4 out of the forward pump light L3 and the forward pump light L4 is input to the PD 214. Thus, the PD 214 detects the power of the secondary pump light L4. The backward control unit 205 obtains this power from the output signal of the PD 214. Thus, the backward control unit 205 may determine that the optical connectors 41 and 42 are coupled. Accordingly, in the case where the power of the secondary pump light L4 is able to be obtained from the output signal of the PD 214, the backward control unit 205 stops generation of the third control signal. Thus, in the case where the optical connectors 41 and 42 are coupled, the safety light control is not performed, and the backward pumping Raman amplifier 200 normally operates.

In the case where the optical connectors 41 and 42 are coupled, the signal light L1 and the ASS light are input to the PD 213. Thus, the PD 213 detects the power of the signal light L1 and the power of the ASS light. The backward control unit 205 obtains these powers from the output signal of the PD 213. Thus, the backward control unit 205 may determine that the optical connectors 41 and 42 are coupled. Accordingly, in the case where the power of the signal light L1 and the power of the ASS light are able to be obtained from the output signal of the PD 213, the backward control unit 205 stops generation of the third control signal.

The network monitoring device 50 obtains various types of information from the forward control unit 105 and transmits the obtained various types of information to the backward control unit 205. For example, the network monitoring device 50 obtains driving information of the second forward pumping light source 102 and transmits the obtained driving information to the backward control unit 205. The driving information is information indicating that the second forward pumping light source 102 is driving. In a case where the output signal of the PD 214 is not received even though the backward control unit 205 receives the driving information, for example, failure of the second forward pumping light source 102 or the PD 214 may be determined.

The network monitoring device 50 transmits to the backward control unit 205 configuration information indicating whether the transmission apparatus 10 includes the forward pumping Raman amplifier 100. In a case where the transmission apparatus 10 does not include the forward pumping Raman amplifier 100, the above-described malfunction of the backward pumping Raman amplifier 200 is not generated. Thus, in this case, the backward control unit 205 may determine whether to perform the safety light control in accordance with the return loss calculated based on the ratio between the power of the backward pump light L2 and the reflected light of the backward pump light L2. In contrast, in a case where the forward pumping Raman amplifier 100 is provided, since the malfunction may be induced, whether to perform the safety light control may be determined based on the power of the secondary pump light L4.

Instead of such configuration information, the network monitoring device 50 may transmit setting information on the setting of the safety light control to the backward control unit 205. For example, the network monitoring device 50 may transmit to the backward control unit 205 setting information indicating that the backward control unit 205 uses the power of the secondary pump light L4 detected by the PD 214. When this setting information is accepted, the backward control unit 205 does not perform the safety light control in a case where the power of the secondary pump light L4 is obtained and performs the safety light control in a case where this power is unable to be obtained. In addition, the backward control unit 205 may accept configuration information or setting information from optical supervisory channel (OSC) light that monitors between the transmission apparatuses 10 and 20. In this case, the backward control unit 205 does not necessarily accept the configuration information or the setting information from the network monitoring device 50.

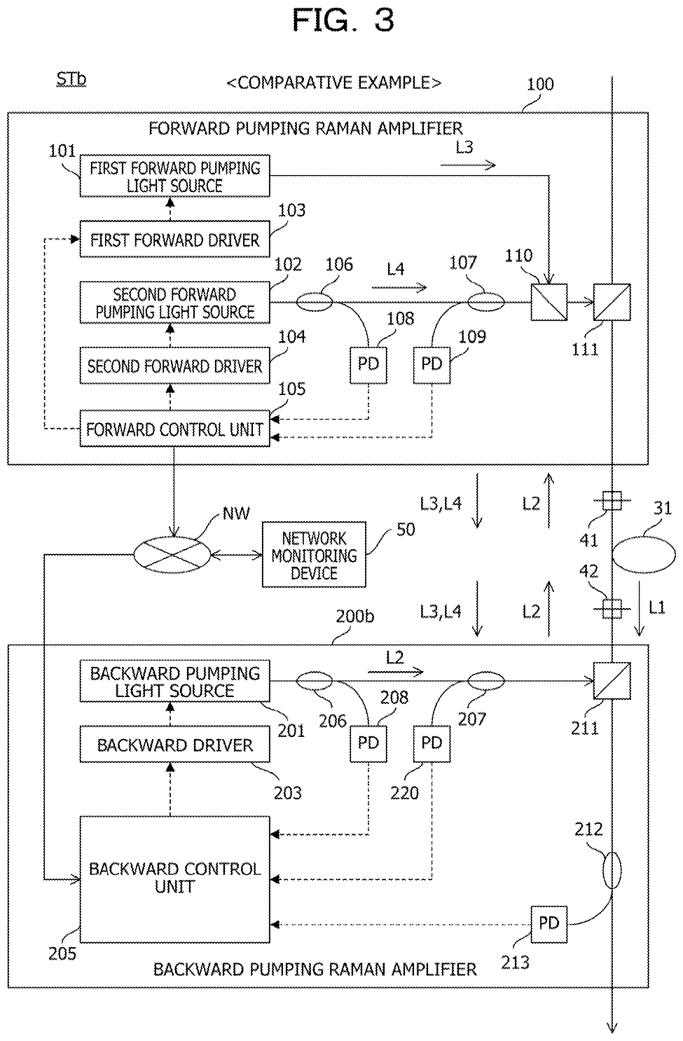

With reference to FIG. 3, an optical amplification system STb according to a comparative example will be described in comparison with the optical amplification system STa according to the first embodiment. In FIG. 3, the same elements as those of the optical amplification system STa having been described with reference to FIG. 2 will be denoted by the same reference numerals, thereby omitting the detailed description thereof.

As illustrated in FIG. 3, the optical amplification system STb according to the comparative example includes the forward pumping Raman amplifier 100 and a backward pumping Raman amplifier 200b. The backward pumping Raman amplifier 200b does not include the optical filter 210 and the PD 214 of the backward pumping Raman amplifier 200 according to the first embodiment described above.

The backward pumping Raman amplifier 200b includes a PD 220 instead of the PD 209 of the backward pumping Raman amplifier 200. The PD 220 is basically provided to detect the power of the reflected light of the backward pump light L2. However, in a case where the forward pump light L3 and the forward pump light L4 are input to the backward pumping Raman amplifier 200b, the PD 220 is able to detect the incoherent pump light L3 of the first wavelength band which is the same as the wavelength band of the reflected light of the backward pump light L2. Accordingly, when the backward control unit 205 calculates the return loss based on the ratio between the power of the backward pump light L2 and the power of the incoherent pump light L3, the return loss is smaller than the threshold even though the optical connectors 41 and 42 are coupled. For example, in the case of the comparative example, even though the optical connectors 41 and 42 are coupled, the safety light control is performed.

According to the first embodiment, the power of the secondary pump light L4 of the second wavelength band is able to be detected by the PD 214. In a case where the power of the secondary pump light L4 is obtained, the backward control unit 205 stops the performance of the safety light control. In a case where the power of the secondary pump light L4 is not obtained, the backward control unit 205 generates the third control signal to perform the safety light control. Thus, malfunction related to the safety light control of the backward pumping Raman amplifier 200 may be suppressed.

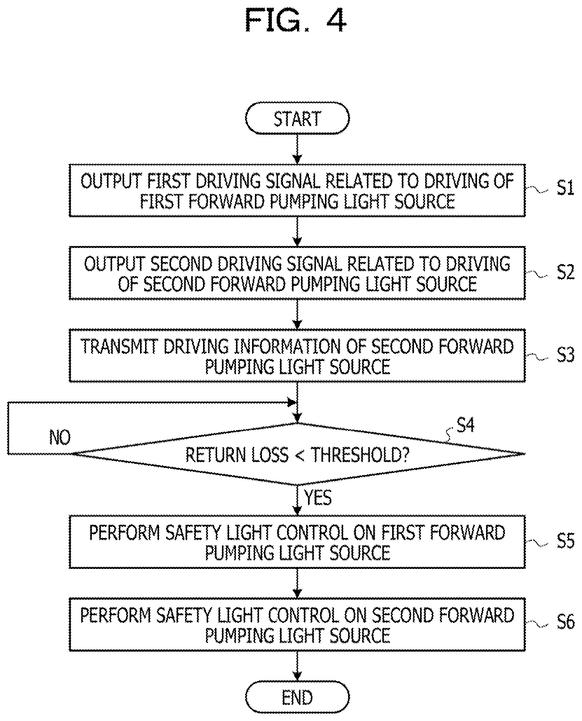

With reference to FIG. 4, operation of the forward control unit 105 according to the first embodiment is described.

For example, when the operator completes coupling of the optical connectors 41 and 42, the forward control unit 105 outputs a first driving signal related to the driving of the first forward pumping light source 101 based on an instruction of the network monitoring device 50 (step S1). In accordance with the first driving signal, the first forward driver 103 drives the first forward pumping light source 101. Thus, the first forward pumping light source 101 outputs the incoherent pump light L3.

When outputting the first driving signal, the forward control unit 105 outputs a second driving signal related to the driving of the second forward pumping light source 102 (step S2). In accordance with the second driving signal, the second forward driver 104 drives the second forward pumping light source 102. Thus, the second forward pumping light source 102 outputs the secondary pump light L4. The forward control unit 105 may output the second driving signal at the same timing as that of the first driving signal. Thus, the incoherent pump light L3 and the secondary pump light L4 are simultaneously output.

When outputting the second driving signal, the forward control unit 105 transmits the driving information of the second forward pumping light source 102 to the network monitoring device 50 (step S3) and stops subsequent processing until the return loss becomes smaller than the threshold (step S4: NO). In more detail, the forward control unit 105 causes the subsequent processing to wait until the return loss based on the ratio between the power of the secondary pump light L4 and the power of the reflected light of the secondary pump light L4 becomes smaller than the threshold. Thus, as long as the optical connectors 41 and 42 are coupled, the performance of the subsequent safety light control is stopped. Upon accepting the driving information, the network monitoring device 50 transmits the driving information to the backward control unit 205.

When the return loss becomes smaller than the threshold (step S4: YES), the forward control unit 105 performs the safety light control on the first forward pumping light source 101 (step S5). For example, when one or both of the optical connectors 41 and 42 are decoupled, the forward control unit 105 generates the first control signal and outputs the generated first control signal to the first forward driver 103. In accordance with the first control signal, the first forward driver 103 performs the safety light control on the first forward pumping light source 101.

When performing the safety light control on the first forward pumping light source 101, the forward control unit 105 performs the safety light control on the second forward pumping light source 102 (step S6), and ends the processing. For example, the forward control unit 105 generates the second control signal and outputs the generated second control signal to the second forward driver 104. In accordance with the second control signal, the second forward driver 104 performs the safety light control on the second forward pumping light source 102. The forward control unit 105 may output the second control signal at the same timing as that of the first control signal. Thus, the safety light control is simultaneously performed on the first forward pumping light source 101 and the second forward pumping light source 102.

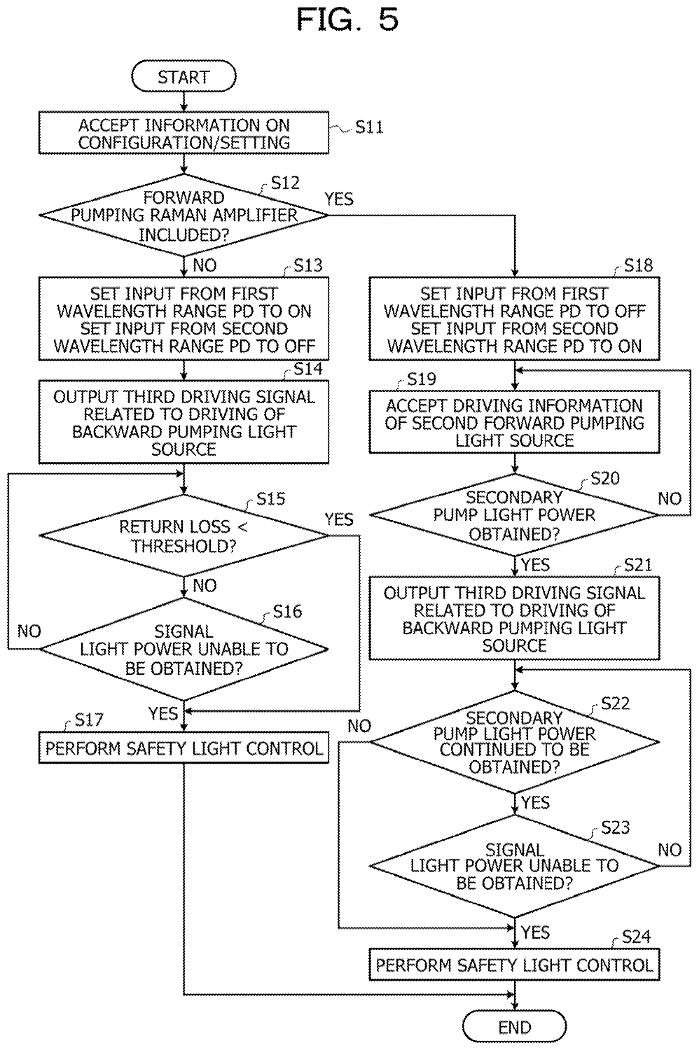

With reference to FIG. 5, operation of the backward control unit 205 according to the first embodiment is described.

When the configuration information or the setting information is transmitted from the network monitoring device 50, the backward control unit 205 accepts the transmitted configuration information or the setting information (step S11). In a case where the configuration information is accepted, the backward control unit 205 determines whether the forward pumping Raman amplifier 100 is included in the transmission apparatus 10 based on the received configuration information (step S12). In a case where the setting information is accepted, the backward control unit 205 determines a method of the safety light control based on the accepted setting information instead of determining whether the forward pumping Raman amplifier 100 is included in the transmission apparatus 10.

For example, in a case where it is determined that the forward pumping Raman amplifier 100 is not included in the transmission apparatus 10 (step S12: NO), the backward control unit 205 sets input of the output signal from a first wavelength range PD to ON and sets input of the output signal from a second wavelength range PD to OFF (step S13). The first wavelength range PD is the PD 209 that detects the power of pump light of the first wavelength band. The second wavelength range PD is the PD 214 that detects the power of pump light of the second wavelength band.

When completing the processing in step S13, the backward control unit 205 outputs a third driving signal related to the driving of the backward pumping light source 201 (step S14) and determines whether the return loss is smaller than the threshold (step S15). In more detail, the backward control unit 205 determines whether the return loss based on the ratio between the power of the backward pump light L2 and the power of the reflected light of the backward pump light L2 is smaller than the threshold.

In a case where the return loss is greater than or equal to the threshold (step S15: NO), the backward control unit 205 determines whether the powers of the signal light L1 and the ASS light are unable to be obtained (step S16). In a case where the powers of the signal light L1 and the ASS light are able to be obtained (step S16: NO), the processing returns to step S15. For example, when the return loss is greater than or equal to the threshold, the fact that the optical connectors 41 and 42 are coupled is able to be identified. In addition, in the case where the optical connectors 41 and 42 are coupled, the backward control unit 205 is able to obtain the powers of the signal light L1 and the ASS light. Thus, in a case where none of two determination conditions which are a determination condition related to the return loss and a determination condition related to the power of, for example, the signal light L1 are satisfied, it may be determined with high accuracy that the optical connectors 41 and 42 are coupled. Accordingly, in this case, the backward control unit 205 waits without performing the safety light control.

In contrast, in the case where the return loss is smaller than the threshold (step S15: YES) or the power of, for example, the signal light L1 is unable be obtained (step S16: YES), the backward control unit 205 performs the safety light control (step S17) and ends the processing. For example, in such a case, it may be determined that the optical connectors 41 and 42 are decoupled, and the backward control unit 205 performs the safety light control.

In a case where it is determined that the forward pumping Raman amplifier 100 is included in the transmission apparatus 10 (step S12: YES), the backward control unit 205 sets the input of the output signal from the first wavelength range PD to OFF and sets the input of the output signal from a second wavelength range PD to ON (step S18). As described above, the first wavelength range PD is the PD 209, and the second wavelength range PD is the PD 214.

When completing the processing in step S18, the backward control unit 205 accepts the driving information of the second forward pumping light source 102 transmitted from the network monitoring device 50 (step S19) and determines whether the power of the secondary pump light L4 is obtained (step S20). In a case where the power of the secondary pump light L4 is not obtained (step S20: NO), the backward control unit 205 executes the processing in step S19 again. For example, in a case where the second forward pumping light source 102 is unable to obtain the power of the secondary pump light L4 despite the acceptance of the driving information, for example, failure of the PD 214 or the like may be assumed.

In a case where the power of the secondary pump light L4 is obtained (step S20: YES), the backward control unit 205 outputs the third driving signal related to the driving of the backward pumping light source 201 (step S21) and determines whether the power of the secondary pump light L4 is continued to be obtained (step S22). In the case where the power of the secondary pump light L4 is continued to be obtained (step S22: YES), the backward control unit 205 determines whether the powers of the signal light L1 and the ASS light are unable to be obtained (step S23). In the case where the powers of the signal light L1 and the ASS light are obtained (step S23: NO), the backward control unit 205 returns to the processing in step S22. For example, when the power of the secondary pump light L4 is continued to be obtained and the powers of the signal light L1 and the ASS light are obtained, it may be determined with high accuracy that the optical connectors 41 and 42 are coupled. In such a case, the backward control unit 205 waits without performing the safety light control.

In contrast, in the case where the power of the secondary pump light L4 is not continued to be obtained (step S22: NO) or the power of, for example, the signal light L1 is unable be obtained (step S23: YES), the backward control unit 205 performs the safety light control (step S24) and ends the processing. For example, in such a case, it may be determined that the optical connectors 41 and 42 are decoupled, and the backward control unit 205 performs the safety light control.

As described above, according to the first embodiment, the malfunction may be suppressed in which, even though the optical connectors 41 and 42 are coupled, the backward pumping Raman amplifier 200 performs the safety light control due to the incoherent pump light L3 output from the forward pumping Raman amplifier 100. Meanwhile, in the case where the optical connectors 41 and 42 are decoupled, the backward pumping Raman amplifier 200 may perform the safety light control depending on the backward pump light L2 and its reflected light. Thus, the safety of the backward pumping Raman amplifier 200 and the optical amplification system STa may be improved.

### Second Embodiment

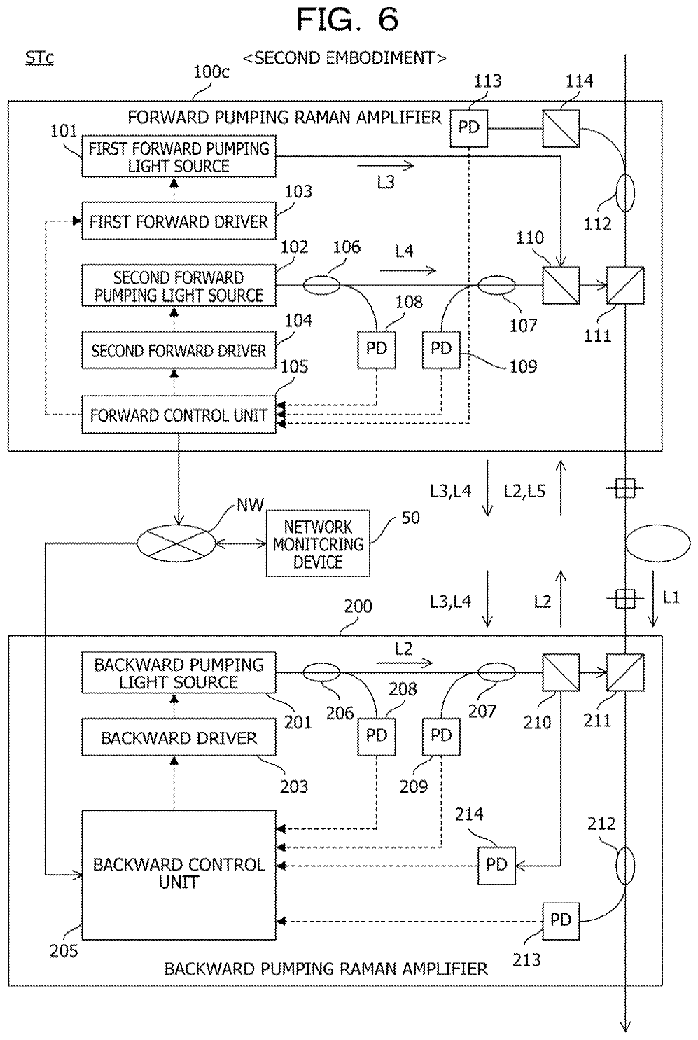

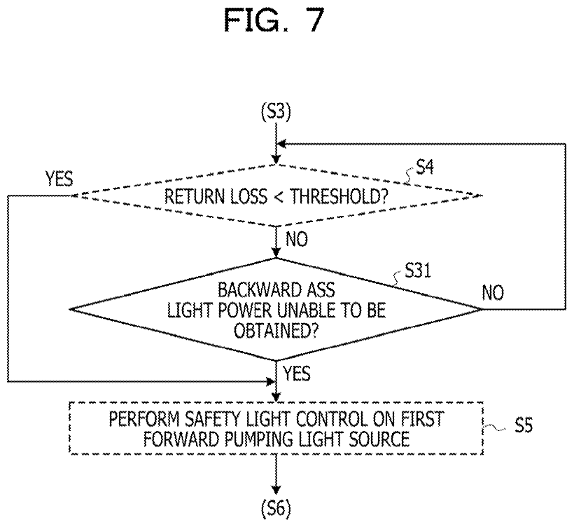

Next, with reference to FIGS. 6 and 7, a second embodiment of the present disclosure will be described. First, with reference to FIG. 6, an optical amplification system STc according to the second embodiment will be described in comparison with the optical amplification system STa according to the first embodiment. In FIG. 6, the same elements as those of the optical amplification system STa having been described with reference to FIG. 2 will be denoted by the same reference numerals, thereby omitting the detailed description thereof.

As illustrated in FIG. 6, the optical amplification system STc according to the second embodiment includes a forward pumping Raman amplifier 100c and the backward pumping Raman amplifier 200. Compared to the forward pumping Raman amplifier 100 according to the first embodiment, the difference between the forward pumping Raman amplifier 100 and the forward pumping Raman amplifier 100c is that the forward pumping Raman amplifier 100c further includes a tap 112, a PD 113, and an optical filter 114. The PD 113 is an example of a detection unit (in more detail, a scattered light detection unit). The optical filters 114 is an example of a filter.

The tap 112 splits and outputs to the optical filter 114 the reflected light of the signal light L1 and backward ASS light L5. The backward ASS light L5 has a wavelength band deviating from the third wavelength band of the signal light L1. The backward ASS light L5 is scattered light that is generated when pump light is input to the optical transmission path 31 and propagates in the opposite direction to the propagation direction of the signal light L1. Since the backward pump light L2 is guided to the optical filter 110 by the optical filter 111, the backward pump light L2 is not input to the tap 112.

The PD 113 detects the power of the backward ASS light L5. The forward control unit 105 obtains this power from an output signal of the PD 113. The reflected light of the signal light L1 and the backward ASS light L5 output from the tap 112 are input to the optical filter 114. The optical filter 114 removes the reflected light of the signal light L1 instead of inputting the reflected light of the signal light L1 to the PD 113 and guides the backward ASS light L5 to the PD 113. Thus, the PD 113 is able to detect the power of the backward ASS light L5.

With reference to FIG. 7, operation of the forward control unit 105 according to the second embodiment is described. Since operation of the backward control unit 205 according to the second embodiment is basically similar to the operation of the backward control unit 205 according to the first embodiment, description of the backward control unit 205 according to the second embodiment is omitted. In FIG. 7, illustration of the processing common with FIG. 4 is omitted.

As illustrated in FIG. 7, in the processing in step S4, when the return loss is smaller than the threshold (step S4: YES), the forward control unit 105 performs the safety light control on the first forward pumping light source 101 in the processing in step S5. After that, in the processing in step S6, the forward control unit 105 performs the safety light control on the second forward pumping light source 102. In the case where one or both of the optical connectors 41 and 42 are decoupled, the return loss based on the ratio between the power of the secondary pump light L4 and the power of the reflected light of the secondary pump light L4 is smaller than the threshold. Accordingly, the forward control unit 105 performs the safety light control on the first forward pumping light source 101 and the second forward pumping light source 102.

Meanwhile, when, for example, the PD 109 fails, there is a possibility that the return loss based on the ratio between the power of the secondary pump light L4 and the power of the reflected light of the secondary pump light L4 is greater than or equal to the threshold. In this case, even though one or both of the optical connectors 41 and 42 are decoupled, the safety light control is not necessarily performed (see FIG. 4). As a result, the secondary pump light L4 may be emitted to a surrounding region. This may impair the safety of the operator.

Accordingly, when the return loss is greater than or equal to the threshold, according to the second embodiment, the forward control unit 105 determines whether the power of the backward ASS light is unable to be obtained (step S31). When the optical connectors 41 and 42 are coupled, the PD 113 is able to detect the power of the backward ASS light. The forward control unit 105 obtains this power from an output signal of the PD 213. When the power is able to be obtained (step S31: NO), the forward control unit 105 executes the processing in step S4 again. For example, even when the PD 109 fails, in the case where the optical connectors 41 and 42 are coupled, the forward control unit 105 may stop, based on the power detected by the PD 113, the performance of the safety light control.

In contrast, in the case where, for example, the optical connector 41 is decoupled, the PD 113 is unable to detect the power of the backward ASS light generated in the optical transmission path 31. Thus, the forward control unit 105 is unable to obtain this power from the output signal of the PD 113. Accordingly, in a case where the forward control unit 105 is unable to obtain the power of the backward ASS light (step S31: YES), it is determined that the optical connector 41 is decoupled, and the safety light control is performed by the processing in steps S5 and S6. Thus, the safety of the operator may be ensured.

Although the preferred embodiments of the present disclosure have been described in detail above, the specific embodiments according to the present disclosure are not limiting, and various modifications and changes may be made within the gist of the present disclosure described in the claims.

For example, although 1450 nm is used as an example of the first wavelength band and 1350 nm narrower than the first wavelength band is used as an example of the second wavelength band, neither the first wavelength band nor the second wavelength band is limited to the above-description. For example, wavelength bands other than 1450 nm and 1350 nm may be used as long as the first wavelength band is longer than the second wavelength band by about 100 nm.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical amplification apparatus comprising:
a light source that outputs to an optical transmission path first pump light which Raman amplifies signal light input from the optical transmission path and which is of a first wavelength band;
a first detector that detects input, from the optical transmission path, of second pump light of a second wavelength band which is different from the first wavelength band; and
a processor that performs safety light control on the light source in a case where the input of the second pump light is not detected.

2. The optical amplification apparatus according to claim 1, further comprising:
a second detector that detects first power of reflected light of the first pump light input from the optical transmission path; and
a third detector that detects second power of the first pump light output to the optical transmission path, wherein
the processor performs the safety light control on the light source based on a ratio between the first power and the second power.

3. The optical amplification apparatus according to claim 1, wherein
the safety light control is control that performs stop control of output of the first pump light or reduction control of the output of the first pump light on the light source.

4. The optical amplification apparatus according to claim 1, wherein
the second pump light is pump light that Raman amplifies incoherent pump light which amplifies the signal light.

5. The optical amplification apparatus according to claim 4, wherein
the second pump light and the incoherent pump light are input from an other optical amplification apparatus coupled to the optical amplification apparatus via the optical transmission path.

6. The optical amplification apparatus according to claim 1, wherein
the second wavelength band is narrower than the first wavelength band.

7. An optical amplification apparatus comprising:
a first light source that outputs to an optical transmission path incoherent pump light which amplifies signal light propagating through the optical transmission path and which is of a first wavelength band;
a second light source that outputs to the optical transmission path pump light which Raman amplifies the incoherent pump light and which is of a second wavelength band different from the first wavelength band;
a filter that blocks reflected light of the signal light input from the optical transmission path and that transmits scattered light input from the optical transmission path in accordance with output of one of the incoherent pump light and the pump light;
a detector that detects input of the scattered light; and
a processor that performs safety light control on each of the first light source and the second light source in a case where the input of the scattered light is not detected.

8. An optical amplification system comprising:
a first optical amplification apparatus; and
a second optical amplification apparatus coupled to the first optical amplification apparatus via an optical transmission path, wherein
the first optical amplification apparatus includes
a first light source that outputs to the optical transmission path incoherent pump light which amplifies signal light propagating through the optical transmission path and which is of a first wavelength band, and
a second light source that outputs to the optical transmission path pump light which Raman amplifies the incoherent pump light and which is of a second wavelength band different from the first wavelength band, wherein
the second optical amplification apparatus includes
a third light source that outputs to the optical transmission path pump light which Raman amplifies the signal light input from the optical transmission path and which is of the first wavelength band,
a pump light detector that detects input, from the optical transmission path, of the pump light of the second wavelength band, and
a first processor that performs safety light control on the third light source in a case where the input of the pump light of the second wavelength band is not detected.

9. The optical amplification system according to claim 8, wherein
the first optical amplification apparatus further includes
a filter that blocks reflected light of the signal light input from the optical transmission path and that transmits scattered light input from the optical transmission path in accordance with output of one of the incoherent pump light and the pump light of the second wavelength band,
a scattered light detector that detects input of the scattered light, and
a second processor that performs the safety light control on each of the first light source and the second light source in a case where the input of the scattered light is not detected.
